(19) United States
(12) Patent Application Publication
(10) Pub. No.: US 2012/0105597 A1
(43) Pub. Date: May 3, 2012

(54) IMAGE PROCESSOR, IMAGE PROCESSING METHOD, AND IMAGE PICKUP APPARATUS

(75) Inventor: Shinichiro Tajiri, Tokyo (JP)

(73) Assignee: SONY CORPORATION, Tokyo (JP)

(21) Appl. No.: 13/272,958

(22) Filed: Oct. 13, 2011

(30) Foreign Application Priority Data
Nov. 2, 2010 (JP) 2010-246509

(51) Int. Cl. H04N 13/02; G06K 9/00

(52) U.S. Cl. 348/49; 382/154; 348/E13.074

(57) ABSTRACT

An image processor capable of obtaining viewpoint images which are allowed to achieve natural stereoscopic image display is provided. The image processor includes a parallax correction section correcting magnitude of parallax, depending on position on an image plane, for each of a plurality of viewpoint images, the viewpoint images having been taken from respective viewpoints different from one another, and each having a nonuniform parallax distribution in the image plane.

### CROSS REFERENCES TO RELATED APPLICATIONS

The present application claims priority to Japanese Patent Application No. 2010-246509 filed on Nov. 2, 2010, the entire content of which is incorporated herein by reference.

### BACKGROUND

The present technology relates to an image processor performing image processing on, for example, an left-viewpoint image and a right-viewpoint image for stereoscopic vision, an image processing method, and an image pickup apparatus including such an image processor.

Various image pickup apparatuses have been proposed and developed. For example, cameras (image pickup apparatuses) including an imaging lens and a shutter which is allowed to switch between transmission (open) state and shielding (close) state of left and right regions thereof have been proposed (for example, refer to Japanese Patent No. 1060618, Japanese Unexamined Patent Application Publication No. 2002-34056, and Japanese Unexamined Patent Application Publication (Published Japanese Translation of PCT Application) No. H9-505906). In these image pickup apparatuses, when the left region and the right region of the shutter alternately open and close in a time-divisional manner, two kinds of images (a left-viewpoint image and a right-viewpoint image) such as images taken from left and right viewpoints are obtainable. When the left-viewpoint image and the right-viewpoint image are presented to human eyes with use of a predetermined technique, humans are allowed to perceive a stereoscopic effect by these images.

Moreover, most of the above-described image pickup apparatuses are intended to take still images. Image pickup apparatuses taking moving images have been also proposed (for example, Japanese Unexamined Patent Application Publication Nos. H10-271534 and 2000-137203), and these image pickup apparatuses use, as an image sensor, a so-called global shutter type CCD (Charge Coupled Device) performing a frame-sequential photodetection drive.

### SUMMARY

However, in recent years, CMOS (Complementary Metal Oxide Semiconductor) sensors which are allowed to achieve lower cost, lower power consumption and higher-speed processing than the CCD have been mainstream. Unlike the above-described CCD, the CMOS sensor is a so-called rolling shutter type image sensor performing a line-sequential photodetection drive. While the above-described CCD captures an entire screen in each frame at a time, the CMOS sensor performs, in a line-sequential manner, exposure or signal readout, for example, from a top of the image sensor to a bottom thereof, thereby causing a time difference in exposure period, readout timing, or the like from one line to another.

Therefore, when the CMOS sensor is used in an image pickup apparatus taking images while performing switching of optical paths by a shutter described above, there is a time difference between an exposure period for all lines in one frame and an open period of each region of the shutter. As a result, images from a plurality of viewpoints are not obtainable with high precision. For example, in the case where two viewpoint images, i.e., a left-viewpoint image and a right-viewpoint image are obtained for stereoscopic vision, transmitted light rays from the left and the right are mixed around a center of each of the viewpoint images; therefore, horizontal parallax does not occur around a screen center where a viewer tends to focus (a stereoscopic effect is not obtainable).

Therefore, it is considered to take images, for example, by controlling switching timings in the shutter, the exposure period, or the like to prevent light rays from different viewpoints from being mixed on one screen. However, in this technique, while desired parallax is obtained, for example, in a central portion of the screen, parallax is reduced (or eliminated) at upper and lower edges of the screen to cause nonuniform parallax on the screen. When stereoscopic display is performed with use of viewpoint images having such a nonuniform parallax distribution, a display image is likely to become unnatural.

It is desirable to provide an image processor and an image processing method capable of obtaining viewpoint images which are allowed to achieve natural stereoscopic image display, and an image pickup apparatus.

According to an example embodiment, there is provided an image processor including: a parallax correction section correcting magnitude of parallax, depending on position on an image plane, for each of a plurality of viewpoint images, the viewpoint images having been taken from respective viewpoints different from one another, and each having a nonuniform parallax distribution in the image plane.

According to an example embodiment, there is provided an image processing method including: correcting magnitude of parallax, depending on position on an image plane, for each of a plurality of viewpoint images, the viewpoint images having been taken from respective viewpoints different from one another, and each having a nonuniform parallax distribution in the image plane.

In the image processor and the image processing method according to the example embodiment, the parallax correction section corrects magnitude of parallax, depending on position on an image plane, for each of a plurality of viewpoint images which have been taken from respective viewpoints different from one another and each have a nonuniform parallax distribution in the image plane. Therefore, in each of the viewpoint images, nonuniformity of the parallax distribution is reduced.

According to an example embodiment, there is provided an image pickup apparatus including: an imaging lens; a shutter allowed to switch between transmission state and shielding state of each of a plurality of optical paths; an image pickup device detecting light rays which have passed through the respective optical paths, to output image pickup data each corresponding to a plurality of viewpoint images which are seen from respective viewpoints different from one another; a control section controlling switching between transmission state and shielding state of the optical paths in the shutter; and an image processing section performing image processing on the plurality of viewpoint images. The image processing section includes a parallax correction section correcting magnitude of parallax, depending on position on an image plane, for each of the plurality of viewpoint images.

In the image pickup apparatus according to the example embodiment, when the shutter switches between transmission state and shielding state of the optical paths, the image pickup device detects light rays which have passed through the optical paths, to output image pickup data each corresponding to the plurality of viewpoint images. In this case, as the image pickup device is operated in a line-sequential manner, there is a time difference in photodetection period from one line to another; however, switching between transmission state and shielding state of respective optical paths is performed in each image pickup frame at an operation timing of the image pickup device, the operation timing being delayed by a predetermined time length from a start timing of a first-line exposure in each image pickup frame, thereby obtaining viewpoint images where light rays from different viewpoints are not mixed. In the viewpoint images obtained in such a manner, the parallax distribution in the image plane is nonuniform; however, the magnitude of parallax is corrected depending on position on the image plane to reduce nonuniformity.

In the image processor, the image processing method, and the image pickup apparatus according to the example embodiment, the parallax correction section corrects magnitude of parallax, depending on position on an image plane, for each of a plurality of viewpoint images which have been taken from respective viewpoints different from one another and each have a nonuniform parallax distribution in the image plane; therefore, nonuniformity of parallax in each viewpoint image is allowed to be reduced. Accordingly, viewpoint images allowed to achieve natural stereoscopic image display are obtainable.

Additional features and advantages are described herein, and will be apparent from the following Detailed Description and the figures.

### BRIEF DESCRIPTION OF THE FIGURES

The accompanying drawings are included to provide a further understanding of the disclosure, and are incorporated in and constitute a part of this specification. The drawings illustrate example embodiments and, together with the specification, serve to explain the principles of the technology.

FIG. 1 is an illustration of a whole configuration of an image pickup apparatus according to an example embodiment of the technology.

FIGS. 2A and 2B are schematic plan views of a shutter illustrated in FIG. 1.

FIG. 3 is a schematic sectional view of the shutter illustrated in FIG. 1.

FIG. 4 is a plot illustrating an example of response characteristics of the shutter illustrated in FIG. 1.

FIG. 5 is a functional block diagram illustrating a configuration example of an image processing section illustrated in FIG. 1.

FIG. 6 is a schematic view for describing a detected-light image in the case of 2D image-taking (without switching of optical paths).

FIG. 7 is a schematic view for describing a principle of obtaining a left-viewpoint image in the image pickup apparatus illustrated in FIG. 1.

FIG. 8 is a schematic view for describing a principle of obtaining a right-viewpoint image in the image pickup apparatus illustrated in FIG. 1.

FIG. 9 is a schematic view for describing parallax between the left-viewpoint image and the right-viewpoint image obtained with use of the image pickup apparatus illustrated in FIG. 1.

FIG. 10 is a schematic view illustrating a relationship between drive timing of an image sensor (CCD) and open/close timing of a shutter according to Comparative Example 1.

FIG. 11 is a schematic view illustrating a relationship between drive timing of an image sensor (CMOS) and open/close timing of a shutter according to Comparative Example 2.

FIGS. 12A and 12B are schematic views of a left-viewpoint image and a right-viewpoint image, respectively, obtained by timing control illustrated in FIG. 11.

FIG. 13 is a schematic view illustrating a relationship between drive timing of an image sensor illustrated in FIG. 1 and open/close timing of the shutter illustrated in FIG. 1.

FIG. 14 is a schematic view of viewpoint images obtained by timing control illustrated in FIG. 13, where parts (A), (B), and (C) illustrate a left-viewpoint image, a right-viewpoint image, and a horizontal parallax distribution, respectively.

FIG. 15 is a schematic view for describing a parallax correction process (an increase in parallax (parallax enhancement)).

FIG. 16 is a schematic view illustrating an example of the parallax correction process (an increase in parallax (parallax enhancement)).

FIG. 17 is a schematic view illustrating a relationship between magnitude of parallax and a stereoscopic effect in images before being subjected to the parallax correction process.

FIG. 18 is a schematic view illustrating a relationship between magnitude of parallax and a stereoscopic effect in images as resultants of the parallax correction process.

FIG. 19 is a functional block diagram illustrating a configuration example of an image processing section according to Example Modification 1.

FIG. 20 is a schematic view for describing a merit of the parallax correction process according to Example Modification 1.

FIG. 21 is a schematic view illustrating a relationship between drive timing of an image sensor and open/close timing of a shutter according to Example Modification 2.

FIGS. 22A to 22C are schematic views of viewpoint images obtained by timing control illustrated in FIG. 21, where FIGS. 22A, 22B and 22C illustrate a left-viewpoint image, a right-viewpoint image, and a horizontal parallax distribution, respectively.

FIG. 23 is a schematic view illustrating an example of a parallax correction process on the viewpoint images illustrated in FIGS. 22A to 22C.

FIG. 24 is a schematic view for describing a parallax correction process (a reduction in parallax (parallax suppression) according to Example Modification 3.

FIG. 25 is an illustration of a whole configuration of an image pickup apparatus according to Example Modification 4.

### DETAILED DESCRIPTION

Embodiments of the present application will be described below in detail with reference to the drawings. Description of example embodiments will be given in the following order.

1. Example Embodiment (Example of image processing in which parallax correction with use of a disparity map is performed on viewpoint images with magnitude of parallax varying with screen position)

2. Example Modification 1 (Example in the case where parallax correction is performed according to spatial frequency)

3. Example Modification 2 (Example of parallax correction on other viewpoint images)

4. Example Modification 3 (Example in the case where magnitude of parallax is reduced)

5. Example Modification 4 (Example of binocular image pickup apparatus)

### Example Embodiment

### [Configuration of Image Pickup Apparatus 1]

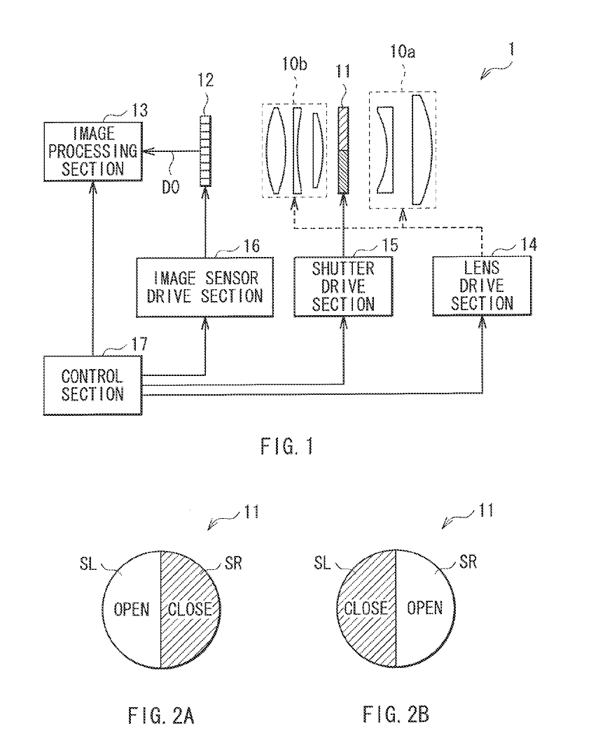

FIG. 1 illustrates a whole configuration of an image pickup apparatus (an image pickup apparatus 1) according to an example embodiment of the technology. The image pickup apparatus 1 takes images of a subject from a plurality of viewpoints different from one another to alternately obtain, as moving images (or still images), a plurality of viewpoint images (herein, two viewpoint images, i.e., a left-viewpoint image and a right-viewpoint image) in a time-divisional manner. The image pickup apparatus 1 is a so-called monocular camera, and is allowed to perform switching of left and right optical paths by shutter control. The image pickup apparatus 1 includes imaging lenses 10a and 10b, a shutter 11, an image sensor 12, an image processing section 13, a lens drive section 14, a shutter drive section 15, an image sensor drive section 16, and a control section 17. It is to be noted that the image processing section 13 corresponds to an image processor of the present technology. Moreover, an image processing method of the technology is embodied by the configuration and operation of the image processing section 13, and will not be described.

The imaging lenses 10a and 10b each are configured of a lens group capturing light rays from the subject, and the shutter 11 is disposed between the imaging lenses 10a and 10b. It is to be noted that the position of the shutter 11 is not specifically limited; however, ideally, the shutter 11 is preferably disposed on pupil planes of the imaging lenses 10a and 10b or in an aperture position (not illustrated). The imaging lenses 10a and 10b function as, for example, so-called zoom lenses, and are allowed to change a focal length by adjusting a lens interval or the like by the lens drive section 14. It is to be noted that the imaging lenses 10a and 10b each are not limited to such a variable focal lens, and may be a fixed focal lens.

### (Configuration of Shutter 11)

The shutter 11 is divided into two regions, i.e., a left region and a right region, and is allowed to separately change transmission (open)/shielding (close) states of the regions. The shutter 11 may be any shutter capable of changing the states of the regions in such a manner, for example, a mechanical shutter or an electrical shutter such as a liquid crystal shutter. The configuration of the shutter 11 will be described in more detail later.

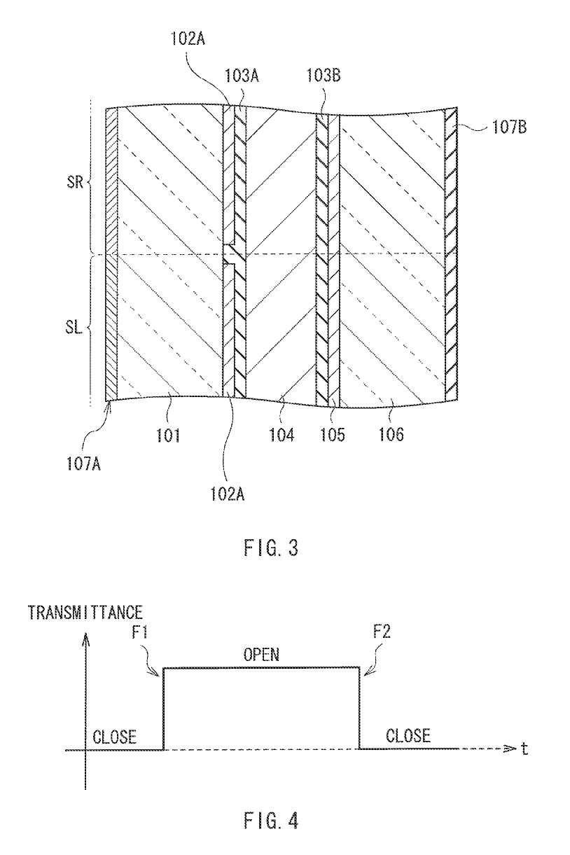

FIGS. 2A and 2B illustrate an example of a planar configuration of the shutter 11. The shutter 11 has two regions (along a horizontal direction), i.e., a left region and a right region (SL and SR), and the shutter 11 is controlled to perform alternate switching between a state where the region SL is opened (the region SR is closed) (refer to FIG. 2A) and a state where the region SR is opened (the region SL is closed) (refer to FIG. 2B). A specific configuration of such a shutter 11 will be described below referring to a liquid crystal shutter as an example. FIG. 3 illustrates a sectional configuration, around a boundary of the regions SL and SR, of the shutter 11 as the liquid crystal shutter.

The shutter 11 is configured by sealing a liquid crystal layer 104 between substrates 101 and 106 made of glass or the like, and bonding a polarizer 107A on a light incident side of the substrate 101 and a analyzer 107B on a light emission side of the substrate 106. An electrode is formed between the substrate 101 and the liquid crystal layer 104, and the electrode is divided into a plurality of (herein, two corresponding to the regions SL and SR) sub-electrodes 102A. These two sub-electrodes 102A are allowed to separately supply a voltage. A common electrode 105 for the regions SL and SR is disposed on the substrate 106 facing such a substrate 101. It is to be noted that the electrode on the substrate 106 is typically, but not exclusively, a common electrode for the regions SL and SR, and may be divided into sub-electrodes corresponding to the regions. An alignment film 103A and an alignment film 103B are formed between the sub-electrode 102A and the liquid crystal layer 104 and between the electrode 105 and the liquid crystal layer 104, respectively.

The sub-electrodes 102A and the electrode 105 are transparent electrodes made of, for example, ITO (Indium Tin Oxide). The polarizer 107A and the analyzer 107B each allow predetermined polarized light to selectively pass therethrough, and are arranged in, for example, a cross-nicol or parallel-nicol state. The liquid crystal layer 104 includes a liquid crystal of one of various display modes such as STN (Super-twisted Nematic), TN (Twisted Nematic), and OCB (Optical Compensated Bend). A liquid crystal preferably used herein is a liquid crystal in which response characteristics when changing the shutter 11 from a close state to an open state (changing an applied voltage from low to high) are substantially equal to response characteristics when changing the shutter 11 from the open state to the close state (changing the applied voltage from high to low) (a waveform is symmetric). Moreover, a liquid crystal ideally used herein is a liquid crystal exhibiting characteristics in which a response when changing from one state to another is extremely fast, for example, as illustrated in FIG. 4, transmittance vertically rises from the close state to the open state (F1) and vertically falls from the open state to the close state (F2). Examples of a liquid crystal exhibiting such response characteristics include an FLC (Ferroelectric Liquid Crystal).

In the shutter 11 with such a configuration, when a voltage is applied to the liquid crystal layer 104 through the sub-electrodes 102A and the electrode 105, transmittance from the polarizer 107A to the analyzer 107B is allowed to be changed according to the magnitude of the applied voltage. In other words, with use of the liquid crystal shutter as the shutter 11, switching between open state and close state in the shutter 11 is allowed to be performed by voltage control. Moreover, when the electrode for voltage application is divided into two sub-electrodes 102A which are allowed to be separately driven, the transmission and shielding states of the regions SL and SR are allowed to be alternately changed.

The image sensor 12 is a photoelectric conversion element outputting a photodetection signal based on a light ray having passed through the imaging lenses 10a and 10b, and a predetermined region of the shutter 11. The image sensor 12 is an rolling shutter type (line-sequential drive type) image pickup device (for example, a CMOS sensor) including, for example, a plurality of photodiodes (photodetection pixels) arranged in a matrix form, and performing exposure and signal readout in a line-sequential manner. It is to be noted that color filters of R, G and B (not illustrated) arranged in predetermined color order may be disposed on a photodetection surface of the image sensor 12.

### (Configuration of Image Processing Section 13)

The image processing section 13 performs predetermined image processing on picked-up images (the left-viewpoint image and the right-viewpoint image) based on image pickup data supplied from the image sensor 12, and includes a memory (not illustrated) storing image pickup data before or after being subjected to the image processing. Image data subjected to the image processing may not be stored, and may be supplied to an external display or the like.

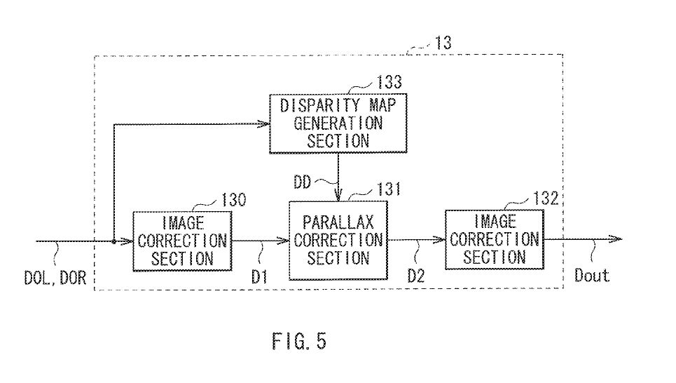

FIG. 5 illustrates a specific configuration of the image processing section 13. The image processing section 13 includes a parallax correction section 131, and a disparity map generation section 133 (a depth information obtaining section), and image correction sections 130 and 132 are disposed in a previous stage and a following stage of the parallax correction section 131, respectively. The parallax correction section 131 changes and controls magnitude of parallax between images (a left-viewpoint image L1 and a right-viewpoint image R1) based on image pickup data (left-viewpoint image data D0L and right-viewpoint image data D0R) supplied from the image sensor 12.

The parallax correction section 131 performs correction of magnitude of parallax between a supplied left-viewpoint image and a supplied right-viewpoint image. More specifically, a plurality of viewpoint images having a nonunfirom parallax distribution in an image plane is subjected to correction of the magnitude of parallax depending on position on the image plane to reduce nonuniformity of the magnitude of parallax. Moreover, in the embodiment, the parallax correction section 131 performs the above-described correction based on a disparity map supplied from the disparity map generation section 133. With use of the disparity map, parallax correction suitable for a stereoscopic effect allowing an image of a subject to appear in front of or behind a screen plane is performed. In other words, the magnitude of parallax is allowed to be corrected, thereby allowing an image of a subject on a back side (a side far from a viewer) to appear farther from the viewer, and allowing an image of a subject on a front side (a side close to the viewer) to appear closer to the viewer (allowing a stereoscopic effect by parallax to be further enhanced).

The disparity map generation section 133 generates a so-called disparity map (depth information) based on image pickup data (left-viewpoint image data D0L and right-viewpoint image data D0R) by, for example, a stereo matching method. More specifically, disparities (phase differences, phase shifts) in respective pixels between the left-viewpoint image and the right-viewpoint image are determined to generate a map where the determined disparities are assigned to the respective pixels. As the disparity map, disparities in respective pixels may be determined, and disparities assigned to the respective pixels may be stored; however, disparities in respective pixel blocks each configured of a predetermined number of pixels may be determined, and disparities assigned to the respective pixel blocks may be stored. The disparity map generated in the disparity map generation section 133 is supplied to the parallax correction section 131 as map data DD.

It is to be noted that “magnitude of parallax” in the specification represents a displacement amount (a phase shift amount) in a horizontal screen direction between the left-viewpoint image and the right-viewpoint image.

The image correction section 130 performs a correction process such as noise reduction or demosaic process, and the image correction section 132 performs a correction process such as a gamma correction process.

The lens drive section 14 is an actuator shifting a predetermined lens in the imaging lenses 10a and 10b along an optical axis to change a focal length.

The shutter drive section 15 separately drives the left and right regions (SL and SR) in the shutter 11 to be opened or closed in response to timing control by the control section 17. More specifically, the shutter drive section 15 drives the shutter 11 to turn the region SR into a close state while the region SL is in an open state, and vice versa. When moving images are taken, the shutter drive section 15 drives the shutter 11 to alternately change open/close states of the regions SL and SR in a time-divisional manner. An open period of each of the left region SL and the right region SR in the shutter 11 correspond to a frame (a frame L or a frame R) at 1:1, and the open period of each region and a frame period are approximately equal to each other.

The image sensor drive section 16 performs drive control on the image sensor 12 in response to timing control by the control section 17. More specifically, the image sensor drive section 16 drives the above-described rolling shutter type image sensor 12 to perform exposure and signal readout in a line-sequential manner.

The control section 17 controls operations of the image processing section 13, the lens drive section 14, the shutter drive section 15, and the image sensor drive section 16 at predetermined timings, and a microcomputer or the like is used as the control section 17. As will be described in detail later, in the example embodiment, the control section 17 adjusts an open/close switching timing in the shutter 11 to be shifted from a frame start timing (a first-line exposure start timing) by a predetermined time length.

[Functions and Effects of Image Pickup Apparatus 1]

(1. Basic Operation)

In the above-described image pickup apparatus 1, in response to control by the control section 17, the lens drive section 14 drives the imaging lenses 10a and 10b, and the shutter drive section 15 turns the left region SL and the right region SR in the shutter 11 into an open state and a close state, respectively. Moreover, the image sensor drive section 16 drives the image sensor 12 in synchronization with these operations. Therefore, switching to the left optical path is performed, and in the image sensor 12, the left-viewpoint image data D0L based on a light ray incident from a left viewpoint is obtained.

Next, the shutter drive section 15 turns the right region and the left region in the shutter 11 into the open state and the close state, respectively, and the image sensor drive section 16 drives the image sensor 12. Therefore, switching from the left optical path to the right optical path is performed, and in the image sensor 12, the right-viewpoint image data D0R based on a light ray incident from a right viewpoint is obtained.

Then, a plurality of frames (image pickup frames) are time-sequentially obtained in the image sensor 12, and the above-described shutter 11 changes the open/close states of the left and right regions in synchronization with timings of obtaining the image pickup frames (frames L and R which will be described later) to alternately obtain image pickup data corresponding to the left-viewpoint image and the right-viewpoint image along a time sequence, and the image pickup data is sequentially supplied to the image processing section 13.

In the image processing section 13, first, the image correction section 130 performs a correction process such as noise reduction or a demosaic process on picked-up images based on the left-viewpoint image data D0L and the right-viewpoint image data D0R obtained in the above-described manner. The image data D1 as a resultant of the image correction process is supplied to the parallax correction section 131. After that, the parallax correction section 131 performs a parallax correction process which will be described later on the viewpoint images (the left-viewpoint image L1 and the right-viewpoint image R1) based on the image data D1 to generate viewpoint images (a left-viewpoint image L2 and a right-viewpoint image R2), and then supplies the viewpoint images to the image correction section 132 as image data D2. The image correction section 132 performs a correction process such as a gamma correction process on the viewpoint images based on the image data D2 to generate image data Dout associated with a left-viewpoint image and a right-viewpoint image. The image data Dout generated in such a manner is stored in the image processing section 13 or is supplied to an external device.

### (2. Principle of Obtaining Viewpoint Image)

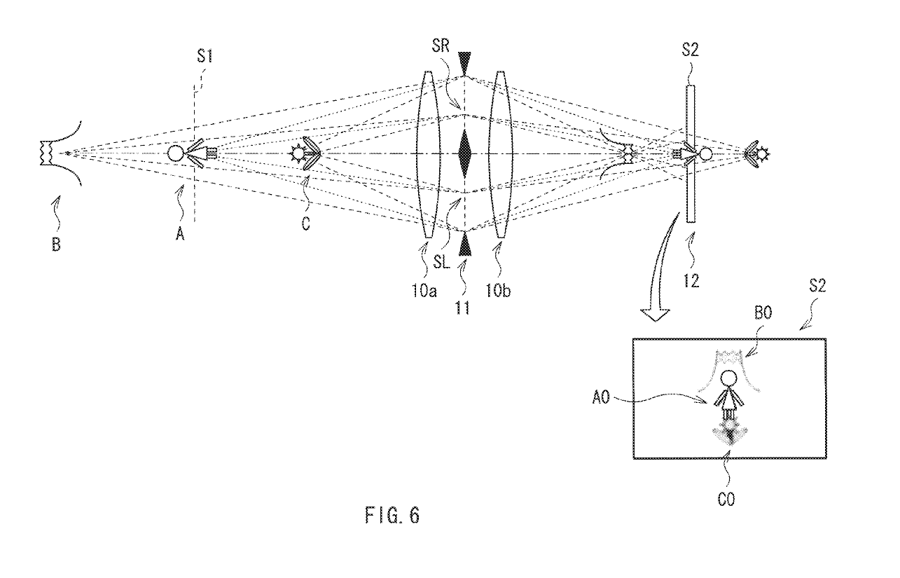

Referring to FIGS. 6 to 8, a principle of obtaining a left-viewpoint image and a right-viewpoint image with use of a monocular camera will be described below. FIGS. 6 to 8 are equivalent to illustrations of the image pickup apparatus 1 viewed from above; however, for simplification, components other than the imaging lenses 10a and 10b, the shutter 11, and the image sensor 12 are not illustrated, and the imaging lenses 10a and 10b are simplified.

First, as illustrated in FIG. 6, a detected-light image (an image appearing on the image sensor 12) in the case where switching of left and right optical paths is not performed (in the case of typical 2D image-taking) will be described below. Herein, three subjects located in positions different from one another in a depth direction are taken as examples. More specifically, the three subjects are a subject A (e.g., a person) on a focal plane S1 of the imaging lenses 10a and 10b, a subject B (e.g., a mountain) located behind the subject A (on a side farther from the imaging lenses 10a and 10b), and a subject C (e.g., a flower) located in front of the subject A (on a side closer to the imaging lenses 10a and 10b). In such a positional relationship, an image of the subject A is formed, for example, around a center on a sensor plane S2. On the other hand, an image of the subject B located behind the focal plane 51 is formed in front of the sensor plane S2 (on a side closer to the imaging lenses 10a and 10b), and an image of the subject C is formed behind the sensor plane S2 (on a side farther from the imaging lenses 10a and 10b). In other words, an image (A0) focused on the subject A, and images (B0 and C0) defocused on the subject B and the subject C (blurred images) appear on the sensor plane S2.

### (Left-Viewpoint Image)

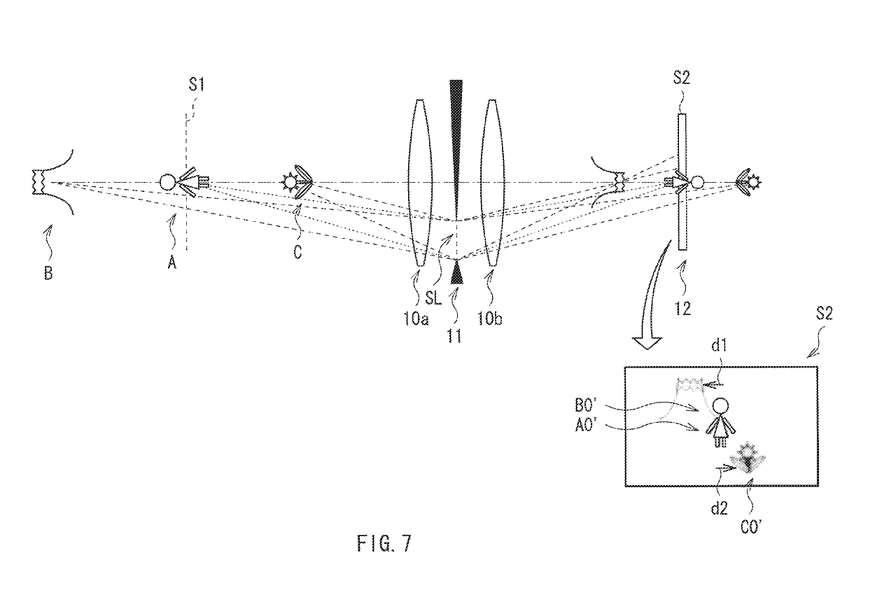

In the case where switching of the left and right optical paths is performed, the images of the three subjects A to C appearing on the sensor plane S2 in such a positional relationship are changed as follows. For example, in the case where the shutter drive section 15 drives the shutter 11 to turn the left region SL and the right region SR into the open state and the close state, respectively, as illustrated in FIG. 7, the left optical path passes through the shutter 11, and the right optical path is shielded by the shutter 11. In this case, even if the right optical path is shielded, the image (A0) focused on the subject A located on the focal plane S1 is formed on the sensor plane S2 as in the above-described case where switching of the optical paths is not performed. However, images defocused on the subjects B and C located out of the focal plane S1 appear as images (B0' and C0') in which the subjects B and C are shifted to horizontal directions (shift directions d1 and d2) opposite to each other, respectively.

(Right-Viewpoint Image)

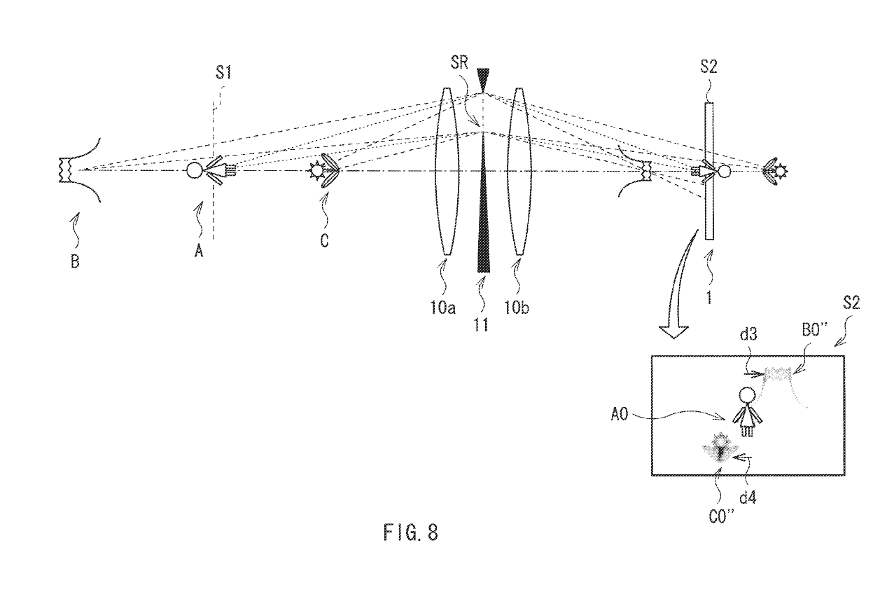

On the other hand, in the case where the shutter drive section 15 drives the shutter 11 to turn the region SR and the region SL into the open state and the close state, respectively, as illustrated in FIG. 8, the right optical path passes through the shutter 11, and the left optical path is shielded. In this case, an image focused on the subject A located on the focal plane 51 is formed on the sensor plane S2, and images defocused on the subjects B and C located out of the focal plane 51 appear as images (B0″ and C0″) in which the subjects B and C are shifted to horizontal directions (shift directions d3 and d4) opposite to each other, respectively. The shift directions d3 and d4 are opposite to the shift directions d1 and d2 in the above-described left-viewpoint image, respectively.

(Parallax Between Left-Viewpoint Image and Right-Viewpoint Image)

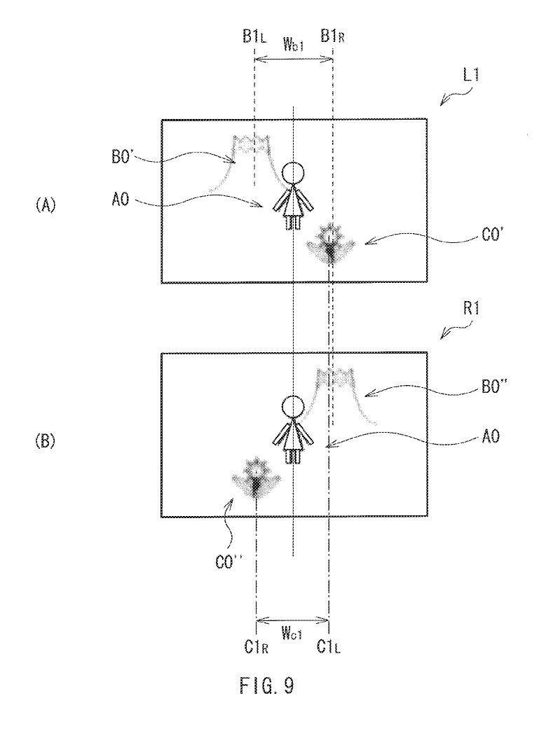

As described above, the open/close states of the regions SL and SR in the shutter 11 are changed to perform switching of the optical paths corresponding to left viewpoint and right viewpoint, thereby obtaining the left-viewpoint image L1 and the right-viewpoint image R1. Moreover, subject images defocused as described above in the left-viewpoint image and the right-viewpoint image are shifted in opposite horizontal directions; therefore, a displacement amount (a phase difference) along the horizontal direction is magnitude of parallax causing a stereoscopic effect. For example, as illustrated in parts (A) and (B) in FIG. 9, in terms of the subject B, a displacement amount Wb1 in the horizontal direction between a position (B1_{L}) of the image B0' in the left-viewpoint image L1 and a position (B1_{R}) of the image B0″ in the right-viewpoint image R1 is magnitude of parallax of the subject B. Likewise, in terms of the subject C, a displacement amount Wc1 in the horizontal direction between a position (C1_{L}) of the image C0' in the left-viewpoint image L1 and a position (C1_{R}) of the image C0″ in the right-viewpoint image R1 is magnitude of parallax of the subject C.

When the left-viewpoint image L1 and the right-viewpoint image R1 are displayed with use of a 3D display method such as a polarization system, a frame sequential system, or a projector system, a viewer is allowed to perceive, for example, the following stereoscopic effect in the viewed images. In the above-described example, images are viewed with such a stereoscopic effect that while the subject A (a person) without parallax appears on a display screen (a reference plane), the subject B (a mountain) appears behind the reference plane, and the subject C (a flower) appears in front of the reference plane.

(3. Drive Timings of Shutter 11 and Image Sensor 12)

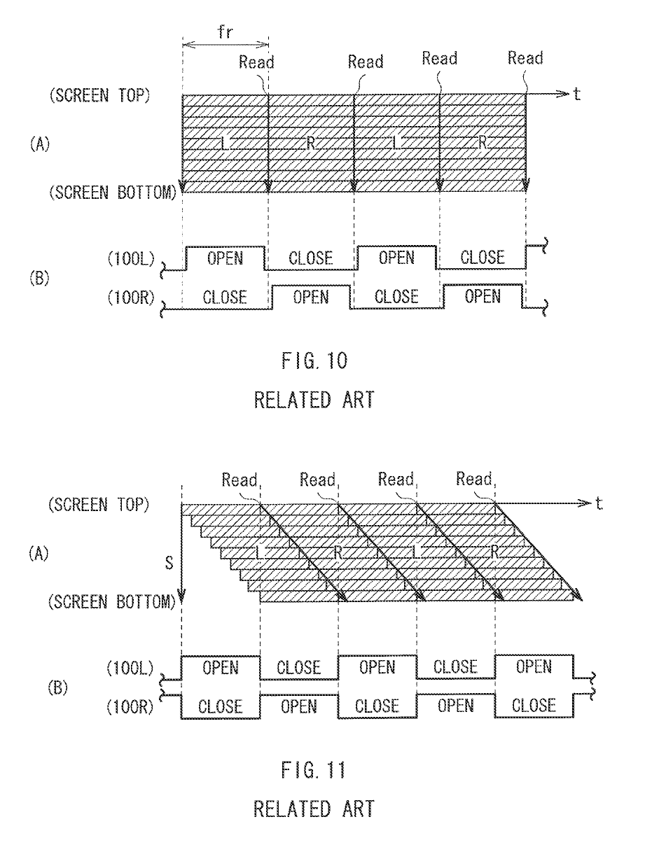

Next, an open/close switching operation in the shutter 11, and exposure and signal readout in the image sensor 12 will be described in detail below referring to comparative examples (Comparative Examples 1 and 2). Parts (A) and (B) in FIG. 10 schematically illustrate exposure/readout timings of an image sensor (CCD) and open/close switching timings of a shutter in Comparative Example 1. Moreover, parts (A) and (B) in FIG. 11 schematically illustrate exposure/readout timings of an image sensor (CMOS) and open/close switching timings of a shutter in Comparative Example 2. It is to be noted that in this specification, a frame period fr corresponds to a period equivalent to a half of a frame period as a moving image (2fr=a frame period as a moving image). Moreover, diagonally shaded portions in the parts (A) in FIGS. 10 and 11 correspond to exposure periods. It is to be noted that description will be given referring to the case where a moving image is taken as an example; however, the same applies to the case where a still image is taken.

### Comparative Example 1

In Comparative Example 1 using a CCD as the image sensor, a screen is collectively driven frame-sequentially; therefore, as illustrated in the part (A) in FIG. 10, there is no time difference in exposure period in a screen (an image pickup screen), and signal readout (Read) is performed simultaneously with exposure. On the other hand, switching between open and close states of a left region 100L and a right region 100R is performed to turn the left region 100L into the open state (while turning the right region 100R into the close state) in an exposure period for the left-viewpoint image and to turn the right region 100R into the open state (while turning the left region 100L into the close state) in an exposure period for the right-viewpoint image (refer to the part (B) in FIG. 10). More specifically, switching between the open and close states of the left region 100L and the right region 100R is performed in synchronization with exposure start (frame period start) timings. Moreover, in Comparative Example 1, open periods of the left region 100L and the right region 100R each are equal to the frame period fr, and are also equal to the exposure period.

### Comparative Example 2

In the case where, for example, a rolling shutter type CMOS sensor is used as the image sensor, unlike the above-described CCD, a drive is performed in a line-sequential manner, for example, from a top of a screen to a bottom thereof (along a scan direction S). In other words, as illustrated in the part (A) in FIG. 11, in a screen, exposure start timings or signal readout (Read) timings vary from a line to another. Therefore, there is a time difference in exposure period from one position to another in the screen. In the case where such a CMOS sensor is used, when switching between open state and close state in the shutter is performed in synchronization with a first-line exposure start timing (refer to the part (B) in FIG. 11), switching of the optical paths is performed before completing exposure of an entire screen (all lines).

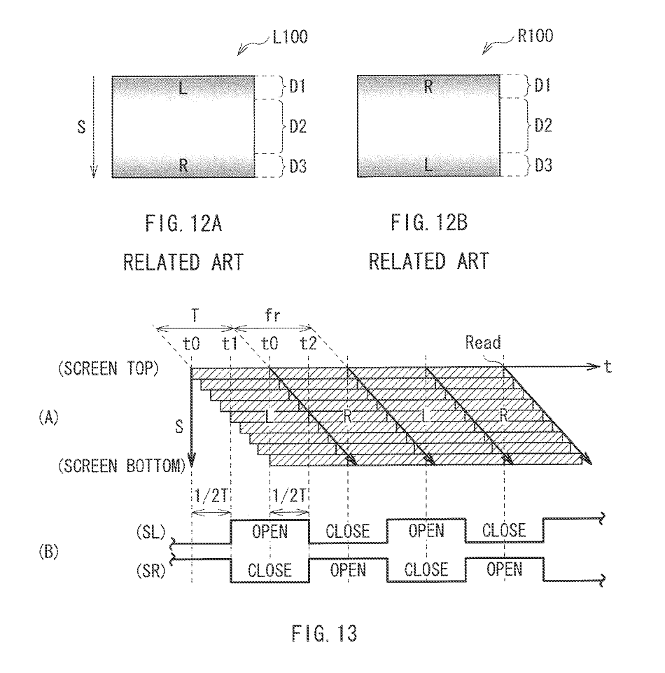

As a result, in the left-viewpoint image L100 and the right-viewpoint image R100, a mixture of light rays passing through optical paths different from each other is detected to cause so-called horizontal crosstalk. For example, in a taken frame of the left-viewpoint image L100, while the amount of detected light rays having passed through the left optical path gradually decreases from the top of the screen to the bottom thereof, the amount of detected light rays having passed through the right optical path gradually increases from the top of the screen to the bottom thereof. Therefore, for example, as illustrated in FIG. 12A, in the left-viewpoint image L100, a upper region D1 is formed mainly based on light rays from a left viewpoint, and a lower region D3 is formed mainly based on light rays from a right viewpoint, and magnitude of parallax around a central region D2 is reduced by a mixture of light rays from respective viewpoints (due to crosstalk). Likewise, in the right-viewpoint image R100, for example, as illustrated in FIG. 12B, the upper region D1 is formed mainly based on light rays from the right viewpoint, and the lower region D3 is formed mainly based on light rays from the left viewpoint, and the magnitude of parallax around the central region D2 is reduced due to crosstalk. It is to be noted that color shading in FIG. 12 represents deviation to one of viewpoint components, and a darker region has a larger amount of detected light rays from one of the left viewpoint and the right viewpoint.

Therefore, in the case where the left-viewpoint image and the right-viewpoint image are displayed in a predetermined method, the magnitude of parallax is reduced (or eliminated) around a center of the screen; therefore, a stereoscopic image is not displayed (an image similar to a planar 2D image is displayed), and a desired stereoscopic effect is not obtained at a top and a bottom of the image (a screen).

Therefore, in the embodiment, in frames (image pickup frames) L and R, switching between open state and close state in the shutter 11 is delayed by a predetermined time length from the first-line exposure start timing in the image sensor 12. More specifically, as illustrated in parts (A) and (B) in FIG. 13, switching between the open and close states of the regions SL and SR in the shutter 11 is delayed by ½ of an exposure period T from a first-line exposure start timing t0. In other words, this is equivalent to the case where switching between the open and close states of the regions SL and SR in the shutter 11 is performed at a central-line exposure start timing t1 in the scan direction S. Therefore, in the frames L and R, light rays having passed through the regions SL and SR of the shutter 11 are detected in an upper region and a lower region of the screen, and light rays having passed from a desired viewpoint are mainly detected around a center of the screen.

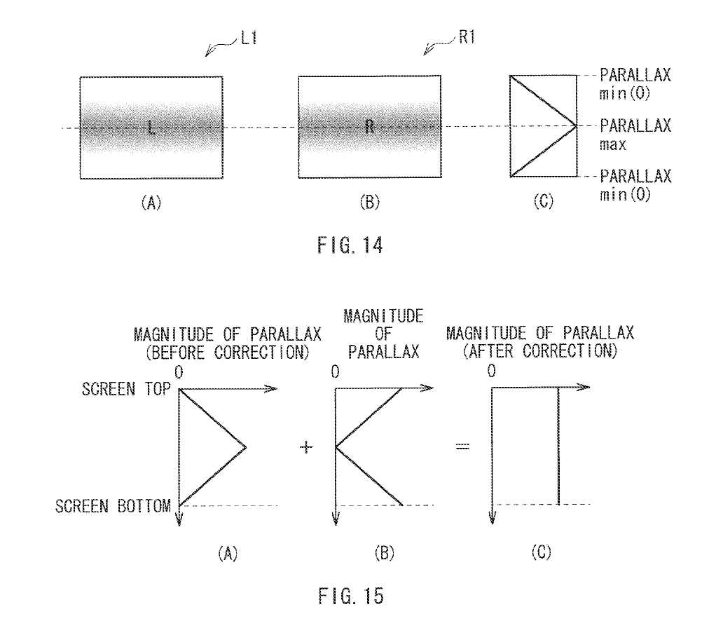

More specifically, as illustrated in a part (A) in FIG. 14, in the left-viewpoint image L1 corresponding to the frame L, the amount of detected light rays from the left viewpoint is largest around a center of a screen, and gradually decreases toward an upper edge and a lower edge of the screen. On the other hand, the amount of detected light rays from the right viewpoint is smallest around the center of the screen, and gradually increases toward the upper edge and the lower edge of the screen. Moreover, as illustrated in a part (B) in FIG. 14, in the right-viewpoint image R1 corresponding to the frame R, the amount of detected light rays from the right viewpoint is largest around the center of the screen, and gradually decreases toward the upper edge and the lower edge of the screen. On the other hand, the amount of detected light rays from the left viewpoint is smallest around the center of the screen, and gradually increases toward the upper edge and the lower edge of the screen. It is to be noted that color shading in the parts (A) and (B) in FIG. 14 represents deviation to one of viewpoint components, and a darker region has a larger amount of detected light rays from the left viewpoint (or the right viewpoint).

Therefore, as illustrated in a part (C) in FIG. 14, the magnitude of parallax between the left-viewpoint image L1 and the right-viewpoint image R1 is largest around the center of the screen, and gradually decreases toward the upper edge and the lower edge of the screen. It is to be noted that in this case, as the amounts of detected light rays from the left viewpoint and the right viewpoint at the upper edge and the lower edge (an uppermost line and a lowermost line) of the screen are ½ and equal to each other, parallax is substantially eliminated (a planar image is formed). Moreover, in the embodiment, the exposure period T and open periods of the regions SL and SR in the shutter 11 are equal to the frame period fr (for example, 8.3 ms), and switching between open state and close state in the shutter 11 is delayed by a period of T/2 (for example, 4.15 ms) from the first-line exposure start timing.

(4. Parallax Correction Process)

As in the case of the above-described left-viewpoint image L1 and the above-described right-viewpoint image R1, in viewpoint images having a nonuniform parallax distribution in an image plane (in the example embodiment, the magnitude of parallax gradually decreases from a center to an upper edge and a lower edge), a stereoscopic effect varies between a central portion of a screen and top and bottom portions thereof, and an unnatural display image is likely to be formed (a viewer is likely to feel a sense of discomfort in images). Therefore, in the example embodiment, the image processing section 13 performs the following parallax correction process on each viewpoint image having such a nonuniform parallax distribution.

More specifically, the parallax correction section 131 performs, depending on position on the image plane, parallax correction on the image data D1 (the left-viewpoint image data D1L and the right-viewpoint image data D1R). For example, in the case where the left-viewpoint image L1 and the right-viewpoint image R1 based on the image data D1 have a parallax distribution illustrated in a part (A) in FIG. 15 (a parallax distribution obtained by timing control illustrated in the parts (A) and (B) in FIG. 13), parallax correction is performed with a correction amount varying from one position to another in the image plane as illustrated in a part (B) in FIG. 15. More specifically, correction is performed to allow the correction amount to be gradually increased from the center of the screen to the upper edge and the lower edge. In other words, the correction amount is adjusted to be larger in a position with a smaller magnitude of parallax, and to be smaller in a position with a larger magnitude of parallax. By such parallax correction depending on screen position, a viewpoint image having a substantially uniform parallax distribution (nonuniformity of the parallax distribution is reduced) is allowed to be generated in the image plane as illustrated in a part (C) in FIG. 15. However, in the embodiment, as will be described in detail later, the magnitude of parallax is enhanced (increased) in a position with a smaller magnitude of parallax to achieve a uniform parallax distribution. Moreover, such correction may be performed, for example, by adjusting the correction amount in each line data in the image data D1.

On the other hand, the disparity map generation section 133 generates a disparity map based on the supplied left-viewpoint image data D0L and the supplied right-viewpoint image data D0R. More specifically, disparities in respective pixels between the left-viewpoint image and the right-viewpoint image are determined to generate a map storing the determined disparities assigned to respective pixels. However, as the disparity map, as described above, the disparities in respective pixels may be determined to be stored; however, disparities in respective pixel blocks each configured of a predetermined number of pixels may be determined, and the determined disparities assigned to the respective pixel blocks may be stored. The disparity map generated in the disparity map generation section 133 is supplied to the parallax correction section 131 as map data DD.

In the embodiment, the parallax correction section 131 performs the above-described parallax correction with use of the disparity map. In this case, the above-described correction is performed depending on position on the image plane by horizontally shifting an image position (changing a phase shift amount); however, a subject image appearing on a front side and a subject image appears on a back side are shifted to directions opposite to each other (as will be described in detail later). In other words, it is necessary to adjust the shift direction of each subject image according to a stereoscopic effect thereof. In the disparity map, depth information corresponding to the stereoscopic effect assigned to each position on the image place is stored; therefore, parallax correction suitable for each of the stereoscopic effects of the subject images is allowed to be performed with use of such a disparity map. More specifically, while the magnitude of parallax is controlled to allow a subject image on a back side (a side far from a viewer) to appear farther from the viewer, and to allow a subject image on a front side (a side close to the viewer) to appear closer to the viewer, the above-described correction is allowed to be performed. In other words, while magnitudes of parallax of a plurality of subject images with different stereoscopic effects are increased to enhance respective stereoscopic effects, a uniform parallax distribution is achievable in the image plane. An example of such an operation of increasing the magnitude of parallax will be described below.

(Operation of Increasing Magnitude of Parallax)

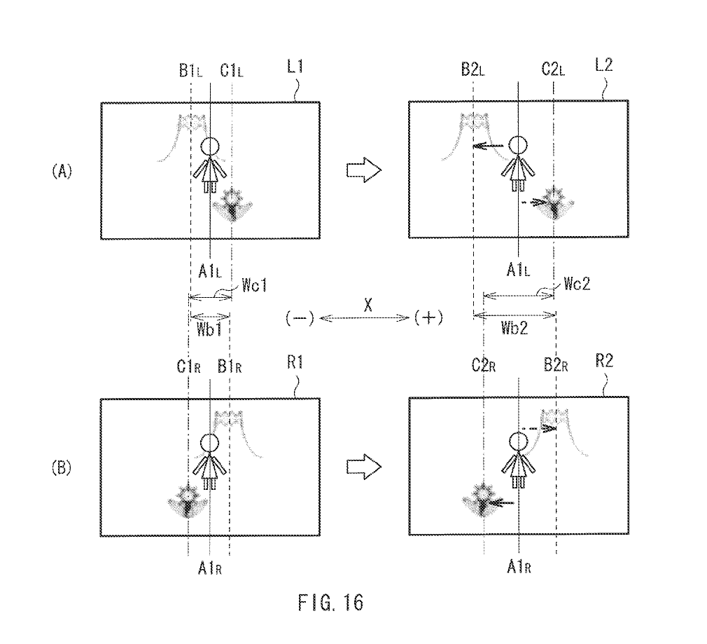

More specifically, as illustrated in parts (A) and (B) in FIG. 16, the parallax correction section 131 shifts the position of the subject B in each of the left-viewpoint image L1 and the right-viewpoint image R1 in a horizontal direction (an X direction) to allow the magnitude of parallax to be increased from W_{b1} to W_{b2} (W_{b1}^{<}W_{b2}). On the other hand, the position of the image of the subject C in each of the left-viewpoint image L1 and the right-viewpoint image R1 is shifted in the horizontal direction to allow the magnitude of parallax to be increased from W_{c1} to W_{c2} (W_{c1}<W_{c2}).

More specifically, the subject B is shifted from a position B1_{L} in a left-viewpoint image L1 to a position B2_{L} in a left-viewpoint image L2 in a negative (−) X direction (indicated by a solid arrow). On the other hand, the subject B is shifted from a position B1_{R} in a right-viewpoint image R1 to a position B2_{R} in a right-viewpoint image R2 in a positive (+) X direction (indicated by a dashed arrow). Therefore, the magnitude of parallax of the subject B is allowed to be increased from Wb1 to Wb2. On the other hand, while the subject C is shifted from a position C1_{L} in the left-viewpoint image L1 to a position C2_{L} in the left-viewpoint image L2 in a positive (+) X direction (indicated by a dashed arrow), the subject C is shifted from a position C1_{R} in the right-viewpoint image R1 to a position C2_{R} in the right-viewpoint image R2 in a negative (−) X direction (indicated by a solid arrow). Therefore, the magnitude of parallax of the subject C is allowed to be increased from Wc₁ to W_{c2}. It is to be noted that positions A1_{L} and A1_{R} of the subject A without parallax are not changed (the magnitude of parallax is kept to be 0) to be disposed in the same position in the left-viewpoint image L2 and the right-viewpoint image R2.

The positions of the subjects B and C illustrated in the above-described parts (A) and (B) in FIG. 16 may be considered as points on some line data of the subjects B and C, and when a parallax increasing process on such point positions is performed, for example, in each line data based on the above-described correction amount distribution, while parallax control suitable for the stereoscopic effect of each subject is performed (each stereoscopic effect is enhanced), the parallax distribution in the image plane is corrected to come to be substantially uniform.

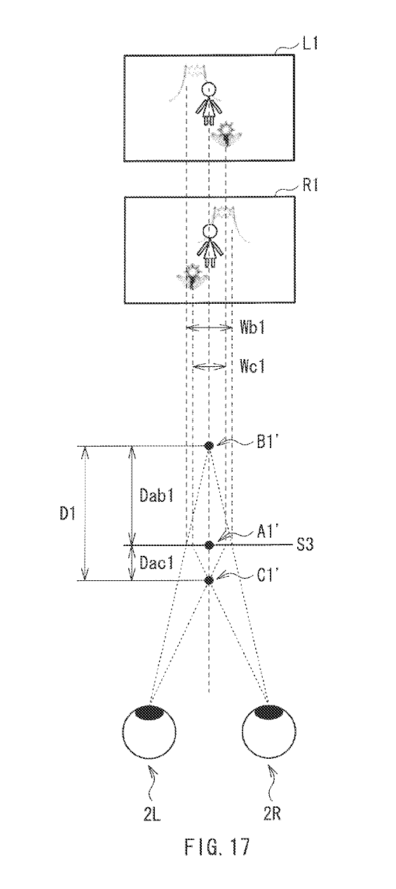

FIG. 17 is a schematic view for describing a relationship between magnitudes of parallax and stereoscopic effects in the left-viewpoint image L1 and the right-viewpoint image R1 corresponding to left-viewpoint image data D0L and right-viewpoint image data D0R, respectively. In the case where the magnitudes of parallax of the subject B and the subject C between the left-viewpoint image L1 and the right-viewpoint image R1 are W_{b1} and W_{c1}, respectively, images of the subjects A to C are viewed in following positions in a depth direction. The image of the subject A is viewed in a position A1' on a display screen (a reference plane) S3, the image of the subject B is viewed in a position BP located behind the subject A by a distance Dab1, and the image of the subject C is viewed in a position C1′ located in front of the subject A by a distance Dac1. In this example, the images of the subjects B and C before being subjected to the parallax increasing process are viewed within a distance range D1 which is equal to the total of the distances Dab1 and Dac1.

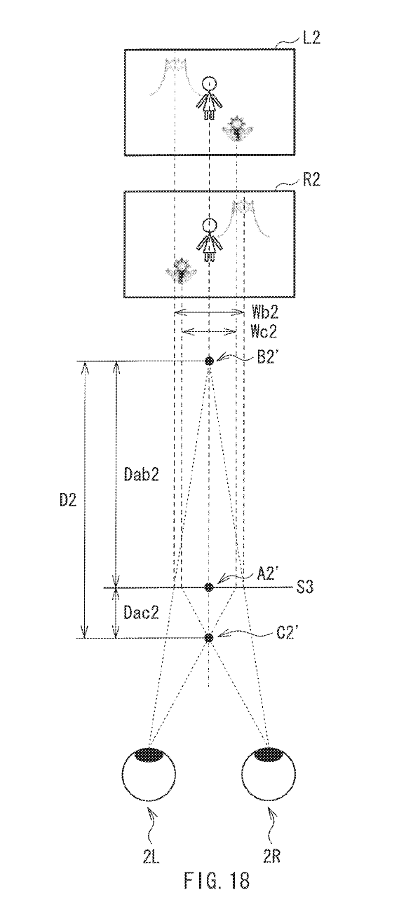

FIG. 18 is a schematic view for describing the magnitudes of parallax and the stereoscopic effects in the left-viewpoint image L2 and the right-viewpoint image R2 as resultants of the parallax increasing process. In the case where the magnitudes of parallax of the subject B and the subject C between the left-viewpoint image L2 and the right-viewpoint image R2 are W_{b2} and W_{c2}, respectively, positions where the subjects A to C are viewed in the depth direction are changed as follows. The image of the subject A is viewed in a position A2′ (=A1') on the display screen (the reference plane) S3, the image of the subject B is viewed in a position B2′ located behind the position A2′ by a distance Dab2 (>Dab1), and the image of the subject C is viewed in a position CT located in front of the position A2′ by a distance Dac2 (>Dac1). Therefore, when the magnitudes of parallax of respective subjects are increased with use of the disparity map, the images of the subjects B and C are viewed within a distance range D2 (>the distance range D1) which is equal to the total of the distances Dab2 and Dac2.

Thus, in the embodiment, when switching between transmission state and shielding state of respective optical paths are performed by the shutter 11, the image sensor 12 detects light rays having passed through respective optical paths to output image pickup data each corresponding to the left-viewpoint image and the right-viewpoint image. In this case, in the line-sequential drive type image sensor 12, there is a time difference in photodetection period from one line to another; however, in each image pickup frame, switching between transmission state and shielding state of respective optical paths is delayed by a predetermined time length from a first-line exposure start timing to obtain viewpoint images in which light rays from the left viewpoint and the right viewpoint are not mixed. In the viewpoint images obtained in such a manner, the parallax distribution in the image plane is nonuniform (parallax is reduced from a central region to an upper edge and a lower edge). The image processing section 13 corrects the magnitude of parallax depending on position on the image plane to reduce nonuniformity of the parallax distribution and to achieve a substantially uniform parallax distribution. Therefore, viewpoint images allowed to achieve natural stereoscopic image display is obtainable.

Next, modifications (Example Modifications 1 to 3) of the parallax correction process according to the above-described embodiment and a modification (Modification 4) of the image pickup apparatus according to the above-described embodiment will be described below. It is to be noted that like components are denoted by like numerals as of the above-described embodiment and will not be further described.

(Example Modification 1)

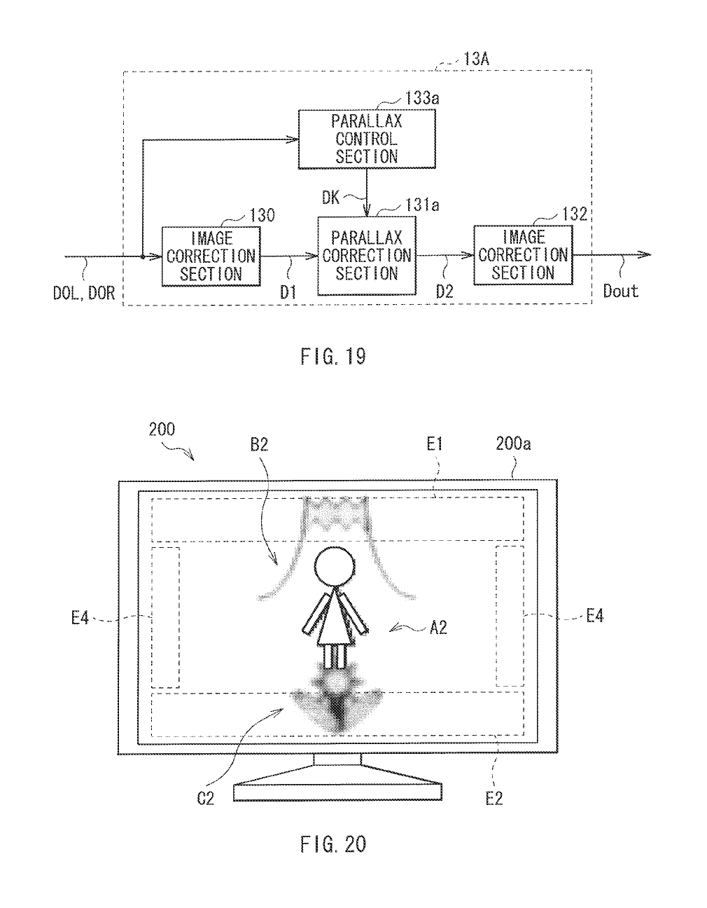

FIG. 19 illustrates a configuration example of an image processing section (an image processing section 13A) according to Example Modification 1. The image processing section 13A performs predetermined image processing including a parallax correction process on a viewpoint image obtained with use of the imaging lenses 10a and 10b, the shutter 11 and the image sensor 12 in the above-described embodiment. The image processing section 13A includes an image correction section 130, a parallax correction section 131a, an image correction section 132, and a parallax control section 133a.

In the example modification, unlike the image processing section 13 in the above-described embodiment, the disparity map generation section 133 is not included, and the parallax correction section 131a performs parallax correction depending on position on the image plane without use of a disparity map (depth information). More specifically, in the image processing section 13A, as in the case of the above-described embodiment, first, the image correction section 310 performs a predetermined correction process on picked-up images based on the left-viewpoint image data D0L and the right-viewpoint image data D0R supplied from the image sensor 12 to supply image data D1 as a resultant of the process to the parallax correction section 131a. On the other hand, the parallax control section 133a performs differential processing on, for example, luminance signals of viewpoint image data D0L and D0R with use of a filter coefficient stored in advance, and then the parallax control section 133a performs non-linear conversion on the luminance signals, thereby determining an image shift amount (parallax control data DK) in a horizontal direction. The determined parallax control data DK is supplied to the parallax correction section 131a.

The parallax correction section 131a adds the image shift amount corresponding to the parallax control data DK to the left-viewpoint image L1 and the right-viewpoint image R1 based on the image data D1. At this time, as in the case of the above-described embodiment, parallax correction is performed depending on position on the image plane. For example, in the case where the left-viewpoint image L1 and the right-viewpoint image R1 have a parallax distribution illustrated in the part (A) in FIG. 15, the above-described image shift amount is enhanced based on, for example, a distribution illustrated in the part (B) in FIG. 15 to allow the parallax distribution in the image plane to come to be substantially uniform while changing and controlling the magnitude of parallax. After the left-viewpoint image L2 and the right-viewpoint image R2 as resultants of the parallax correction process are supplied to the image correction section 132 as image data D2, the image correction section 132 performs a predetermined correction process on the left-viewpoint image L2 and the right-viewpoint image R2, and then the left-viewpoint image L2 and the right-viewpoint image R2 as image data Dout are stored, or supplied to an external device. In the modification, parallax correction may be performed with use of a technique of controlling magnitude of parallax according to a spatial frequency in a viewpoint image.

However, in the parallax correction process in the modification, an image shift direction is limited to one horizontal direction. In other words, a subject image is shifted to one of a backward direction and a forward direction from a display plane. It is to be noted that to which horizontal direction the subject image is shifted is allowed to be set by a filter coefficient used in the above-described parallax control section 133a. Therefore, in the modification, unlike the above-described embodiment using the disparity map, irrespective of whether a subject is displayed on a back side or on a front side, the position where a subject image is displayed is shifted to only one of a backward direction and a forward direction. In the case where description is given, for example, referring to the above-described example, both of the display positions of the subject B on a back side and the subject C on a front side are controlled to be shifted backward or forward. In other words, while one of the subjects B and C has an enhanced stereoscopic effect, the other has a suppressed stereoscopic effect.

Moreover, the image shift direction may be selected by a user or automatically. However, in consideration of the following so-called frame effect, parallax correction is preferably performed while shifting an image backward from the display screen. In other words, in actual stereoscopic display, the left-viewpoint image and the right-viewpoint image are displayed on a display or the like by a predetermined technique, and in this case, a stereoscopic effect around upper and lower edges of an image to be displayed is easily affected by a frame of the display. More specifically, as illustrated in FIG. 20, in the case where an image is displayed on a display 200, viewer's eyes see a frame 200a together with a displayed image. For example, as in the above-described example, in the case where stereoscopic display is performed to allow a person A2 to appear on a display screen, and to allow a mountain B2 and a flower C2 to appear behind and in front of the display screen, respectively, for example, around a region E2, a sense of distance to the flower C2 and a sense of distance to a bottom frame of the frame 200a may be different from each other to cause a conflict therebetween. Likewise, around a region E1, a sense of distance to the mountain B2 and a sense of distance to a top frame of the frame 200a may conflict with each other. Therefore, a displayed image may be pulled to a plane (the display screen) corresponding to a frame surface of the frame 200a (a stereoscopic effect is reduced) to cause a sense of discomfort. Such an influence of the frame 200a is easily exerted on a stereoscopic effect specifically in an image (the flower C2 in the region E2 in this case) displayed with a stereoscopic effect allowing the image to appear in front of the frame 200a (on a side closer to the viewer). Therefore, parallax control is preferably performed to suppress a stereoscopic effect allowing an image to appear in front of the display screen, that is, to shift the subject image backward.

(Example Modification 2)

Parts (A) and (B) in FIG. 21 schematically illustrate drive timings of a image sensor (CMOS) and open/close timings of a shutter according to Example Modification 2. In the modification, as in the case of the above-described example embodiment, in the line-sequential drive image sensor 12, switching between open state and close state in the shutter 11 is delayed by a predetermined time length from a first-line exposure start timing. Moreover, an open period of each region in the shutter 11 corresponds to a frame (a frame L or a frame R) corresponding to the region at 1:1, and the open period of each region and a frame period are approximately equal to each other. However, in the modification, in the image sensor 12, an exposure period in each line is reduced (frame period fr>exposure period T′). At this time, exposure of a first line starts in synchronization with the start of the frame period fr to perform signal readout during the exposure period T′ (the timing of signal readout is accelerated by a predetermined time length, and the exposure start timing is not changed).

The exposure period in the image sensor 12 is adjustable with use of an electronic shutter function or the like. In this case, the frame period fr (=the open period (close period) of the shutter 11) is 8.3 ms, and the exposure period is reduced to approximately 60% of an exposure possible period (the exposure period T′=8.3×0.6=5 ms). Moreover, as in the case of the above-described embodiment, switching between open state and close state in the shutter 11 is delayed by, for example, a period (2.5 ms) equal to ½ of the exposure period T′ from the first-line exposure start timing.

Therefore, a mixture of light rays having passed through the regions SL and SR in the shutter 11 is detected in an upper region and a lower region of the screen in each of the frames L and R; however, light rays from a desired viewpoint are mainly detected around a center thereof. Moreover, in the modification, a range where light rays from a desired viewpoint are obtained (a range along the scan direction S) is widened.

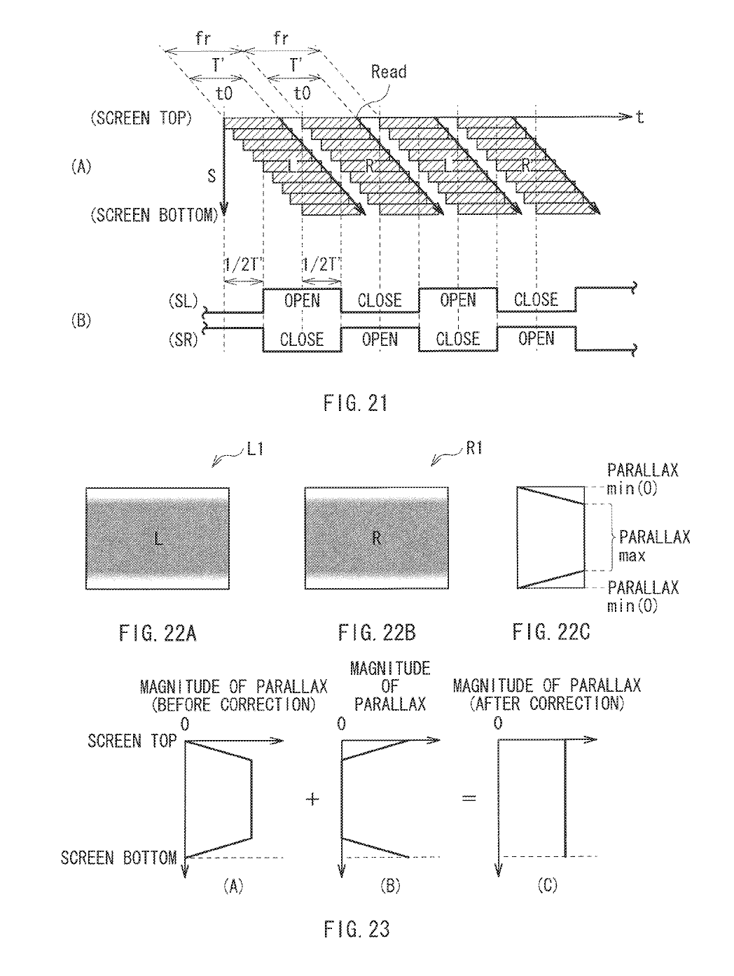

More specifically, as illustrated in a part (A) in FIG. 22, in the left-viewpoint image L1, the amount of detected light rays from the left viewpoint is largest around a center of a screen, and gradually decreases toward an upper edge and a lower edge of the screen. On the other hand, light rays from the right viewpoint are not detected around the center of the screen, and are detected only around the upper edge and the lower edge of the screen. Moreover, as illustrated in a part (B) in FIG. 22, in the right-viewpoint image R1, the amount of detected light rays from the right viewpoint is largest around a center of a screen, and gradually decreases toward an upper edge and a lower edge of the screen. On the other hand, light rays in the left viewpoint are not detected around the center of the screen, and are detected only around the upper edge and the lower edge of the screen. It is to be noted that color shading in the parts (A) and (B) in FIG. 22 represents deviation to one of viewpoint components, and a darker region has a larger amount of detected light rays from the left viewpoint (or the right viewpoint). Therefore, as illustrated in a part (C) in FIG. 22, the magnitude of parallax between the left-viewpoint image L1 and the right-viewpoint image R1 has a parallax distribution in which the magnitude of parallax is increased within a wide range from the center to proximity to the upper and lower edges of the screen and gradually decreases from the proximity to the upper and lower edges of the screen to the upper and the lower edges. It is to be noted that the amounts of detected light rays from the left viewpoint and the right viewpoint at the upper edge and the lower edge (an uppermost line and a lowermost line) of the screen are ½ and equal to each other; therefore, the magnitude of parallax is 0 (zero).

As in the modification, the parallax distribution of the viewpoint image is not limited to that described in the above-described embodiment. Parallax correction may be performed on a viewpoint image having a nonuniform parallax distribution in the image plane based on a correction amount distribution determined according to the parallax distribution. For example, when a parallax correction process is performed, based on a correction amount distribution as illustrated in a part (B) in FIG. 23, on the viewpoint image having a parallax distribution as illustrated in a part (A) in FIG. 23, a viewpoint image having a uniform parallax distribution as illustrated in a part (C) in FIG. 23 is obtainable.

(Example Modification 3)

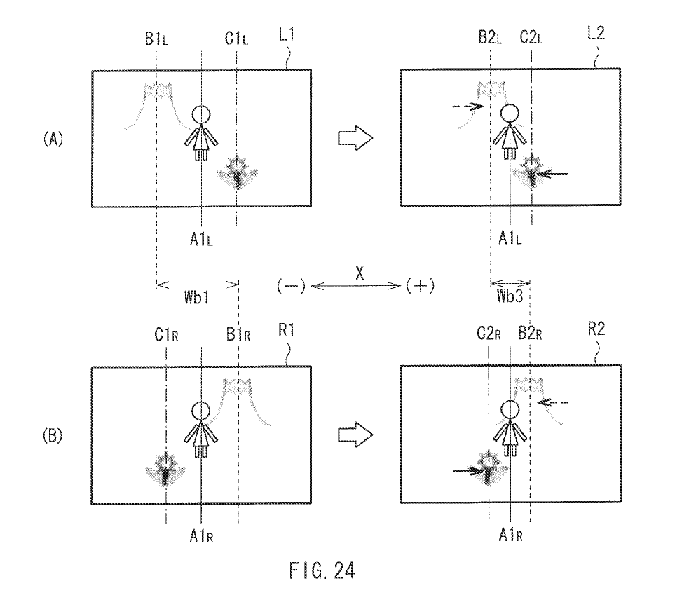

In the above-described example embodiment, an operation of increasing (enhancing) magnitude of parallax is described as an example of a parallax control operation; however, in parallax correction, the magnitude of parallax may be changed and controlled to be reduced (suppressed). In other words, for example, in the case where description is given referring to an example of the above-described parallax distribution as illustrated in the part (A) in FIG. 15, while the magnitudes of parallax at an upper edge and an lower edge of a screen are enhanced, the magnitude of parallax at a center of the screen may be suppressed to allow a parallax distribution as an entire screen to come to be substantially uniform. Parts (A) and (B) in FIG. 24 illustrate schematic views for describing a parallax reducing process. Thus, in the left-viewpoint image L1 and the right-viewpoint image R1, the positions of the subjects B and C are shifted along a horizontal direction (an X direction) to reduce the magnitudes of parallax of the subjects B and C.

More specifically, the subject B is shifted from a position B1_{L} in the left-viewpoint image L1 to a position B2_{L} in the left-viewpoint image L2 in a positive (+) X direction (indicated by a dashed arrow). On the other hand, the subject B is shifted from a position B1_{R} in the right-viewpoint image R1 to a position B2_{R} in the right-viewpoint image R2 in a negative (−) X direction (indicated by a solid arrow). Therefore, the magnitude of parallax of the subject B is allowed to be reduced from W_{b1} to W_{b3} (W_{b1}>W_{b3}). On the other hand, the magnitude of parallax of the subject C is reduced in a similar manner. However, the subject C is shifted from a position C1_{L} in the left-viewpoint image L1 to a position C2_{L} in the left-viewpoint image L2 in a negative (−) X direction (indicated by a solid arrow). On the other hand, the subject C is shifted from a position C1_{R} in the right-viewpoint image R1 to a position C2_{R} in the right-viewpoint image R2 in a positive (+) X direction (indicated by a dashed arrow).

Thus, in the parallax correction process, the magnitude of parallax is controllable not only to be increased, but also to be reduced.

(Example Modification 4)

[Whole Configuration of Image Pickup Apparatus 2]

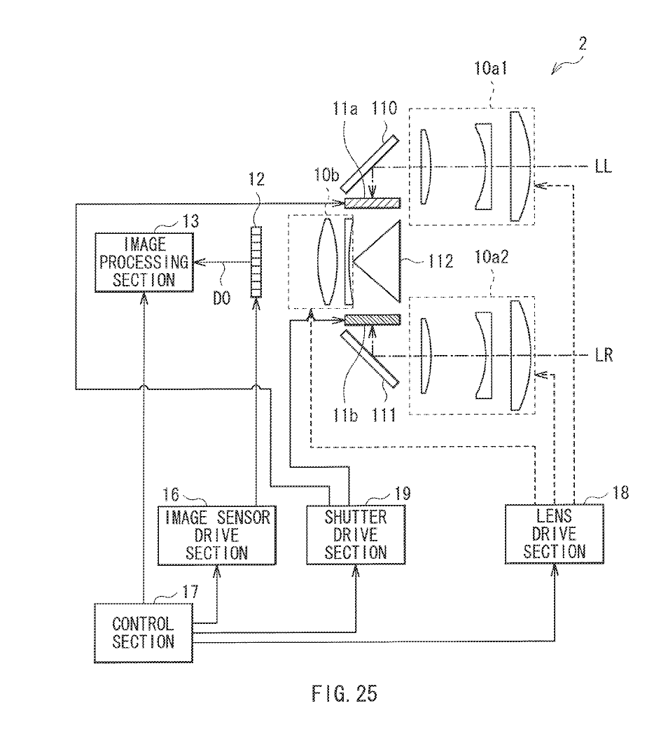

FIG. 25 illustrates a whole configuration of an image pickup apparatus (an image pickup apparatus 2) according to Example Modification 4. As in the case of the image pickup apparatus 1 according to the above-described example embodiment, the image pickup apparatus 2 takes images of a subject from the left viewpoint and the right viewpoint to obtain a left-viewpoint image and a right-viewpoint image as moving images (or still images). However, the image pickup apparatus 2 according to the modification is a so-called binocular camera having imaging lenses 10a1 and 10b and imaging lenses 10a2 and 10b on optical paths for capturing light rays LL and LR from the left viewpoint and the right viewpoint, and includes shutters 11a and 11b on respective optical paths. The imaging lens 10b is a common component for respective optical paths. Moreover, as common components for the respective optical paths, as in the case of the image pickup apparatus 1 according to the above-described embodiment, the image pickup apparatus 2 includes the image sensor 12, the image processing section 13, a lens drive section 18, a shutter drive section 19, the image sensor drive section 16, and the control section 17.

The imaging lenses 10a1 and 10b each are configured of a lens group capturing a light ray LL from the left viewpoint, and the imaging lenses 10a2 and 10b each are configured of a lens group capturing a light ray LR from the right viewpoint. The shutter 11a is disposed between the imaging lenses 10a1 and 10b, and the shutter 11b is disposed between the imaging lenses 10a2 and 10b. It is to be noted that the positions of the shutters 11a and 11b are not specifically limited; however, ideally, the shutters 11a and 11b are preferably disposed on pupil planes of the imaging lenses or in an aperture position (not illustrated).

The imaging lenses 10a1 and 10b (the imaging lenses 10a2 and 10b) function as, for example, zoom lenses as a whole. The imaging lenses 10a1 and 10b (the imaging lenses 10a2 and 10b) is allowed to change a focal length by adjusting a lens interval or the like by the lens drive section 14. Moreover, each of the lens group is configured of one lens or a plurality of lenses. Mirrors 110, 111, and 112 are disposed between the imaging lens 10a1 and the shutter 11a, between the imaging lens 10a2 and the shutter 11b, and the between shutters 11a and 11b, respectively. These mirrors 110 to 112 allow the light rays LL and LR to pass through the shutters 11a and 11b, and then enter into the imaging lens 10b.

The shutters 11a and 11b is provided to switch between transmission state and shielding state of the left and right optical paths, and controls switching between open (light transmission) state and close (light-shielding) state of the shutters 11a and 11b. The shutters 11a and 11b each may be any shutter capable of performing the above-described switching of optical paths, for example, a mechanical shutter or an electrical shutter such as a liquid crystal shutter.

The lens drive section 18 is an actuator allowing a predetermined lens in the imaging lenses 10a1 and 10b (or the imaging lenses 10a2 and 10b) to be shifted along an optical axis.

The shutter drive section 19 performs an open/close switching drive of each of the shutters 11a and 11b. More specifically, the shutter drive section 19 drives the shutter 11b to be turned into a close state while the shutter 11a is in an open state, and vice versa. Moreover, when viewpoint images are obtained as moving images, the shutter drive section 19 drives the shutters 11a and 11b to be alternately turned into an open state and a close state in a time-divisional manner.

[Functions and Effects of Image Pickup Apparatus 2]

In the above-described image pickup apparatus 2, in response to control by the control section 17, the lens drive section 18 drives the imaging lenses 10a1 and 10b, and the shutter drive section 19 turns the shutter 11a and the shutter 11b into an open state and a close state, respectively. Moreover, the image sensor drive section 16 drives the image sensor 12 to detect light in synchronization with these operations. Therefore, switching to the left optical path corresponding to the left viewpoint is performed, and the image sensor 12 detects the light ray LL of incident light rays from the subject to obtain the left-viewpoint image data D0L.

Next, the lens drive section 18 drives the imaging lenses 10a2 and 10b, and the shutter drive section 19 turns the shutter 11b and the shutter 11a into an open state and a close state, respectively. Moreover, the image sensor drive section 16 drives the image sensor 12 to detect light in synchronization with these operations. Therefore, switching to the right optical path corresponding to the right viewpoint is performed, and the image sensor 12 detects the light ray LR of incident light rays from the subject to obtain the right-viewpoint image data D0R. The above-described alternate switching of the imaging lenses 10a1 and 10a2 and the above-described alternate switching between open state and close state of the shutters 11a and 11b are performed in a time-divisional manner to alternately obtain image pickup data corresponding to the left-viewpoint image and the right-viewpoint image along a time sequence, and sequentially supply a combination of the left-viewpoint image and the right-viewpoint image to the image processing section 13.

At this time, as in the case of the above-described example embodiment, in image pickup frames, switching between open state and close state of the shutters 11a and 11b is delayed by a predetermined time length from a first-line exposure start in the image sensor 12. Therefore, as in the case of the above-described embodiment, for example, a viewpoint image having a parallax distribution as illustrated in the part (C) in FIG. 14 and the part (A) in FIG. 15 is allowed to be generated.

Then, the image processing section 13 performs predetermined image processing including the parallax correction process described in the above-described embodiment on picked-up images based on the left-viewpoint image data D0L and the right-viewpoint image data D0R obtained as described above to generate, for example, the left-viewpoint image and the right-viewpoint image for stereoscopic vision. The generated viewpoint images are stored in the image processing section 13, or supplied to an external device.

As described above, the technology is applicable to a binocular camera configured by disposing the imaging lenses for the left and right optical paths, respectively.

Although the present technology is described referring to the embodiment and the modifications, the technology is not limited thereto, and may be variously modified. For example, in the above-described embodiment and the like, as examples of a parallax control technique in the parallax correction process, a technique using a disparity map by stereo matching, and a technique of shifting an image according to a spatial frequency are described; however, the parallax correction process in the technology is also achievable with use of a technique other than the above-described parallax control techniques.

Moreover, in the above-described example embodiment and the like, the case where predetermined image processing is performed on two viewpoint images, i.e., the left-viewpoint image and the right-viewpoint image by switching two optical paths, i.e., the left optical path and the right optical path is described as an example; however, viewpoints are not limited to the left and right viewpoints (horizontal directions), and may be top and bottom viewpoints (vertical directions).

Further, switching of three or more optical paths may be performed to obtain three or more viewpoint images. In this case, for example, as in the case of the image pickup apparatus 1 according to the above-described example embodiment, the shutter may be divided into a plurality of regions, or as in the case of the image pickup apparatus 2 according to Example Modification 4, a plurality of shutters may be disposed on optical paths, respectively.

In addition, in the above-described embodiment and the like, as the viewpoint image having a nonuniform parallax distribution, an image taken by the image pickup apparatus using a CMOS sensor through delaying open/close switching timings of the shutter by ½ of the exposure period is used; however, open/close switching timings of the shutter is not specifically limited thereto. When a viewpoint image to be corrected has a nonuniform parallax distribution in the image plane, purposes of the present technology are achievable.

It should be understood that various changes and modifications to the presently preferred embodiments described herein will be apparent to those skilled in the art. Such changes and modifications can be made without departing from the spirit and scope and without diminishing its intended advantages. It is therefore intended that such changes and modifications be covered by the appended claims.

The invention is claimed as follows:

1. An image processor comprising:
a parallax correction section correcting magnitude of parallax, depending on position on an image plane, for each of a plurality of viewpoint images, the viewpoint images having been taken from respective viewpoints different from one another, and each having a nonuniform parallax distribution in the image plane.

2. The image processor according to claim 1, wherein
the parallax correction section corrects the magnitude of parallax to allow the parallax distribution in the image plane to come to be substantially uniform.

3. The image processor according to claim 2, wherein
the viewpoint images each have a parallax distribution in which the magnitude of parallax gradually decreases from center to edge in the image plane, and
the parallax correction section corrects the magnitude of parallax to allow the magnitude of parallax to be gradually enhanced from center to edge in the image plane.

4. The image processor according to claim 1, wherein
when each of the viewpoint images includes a plurality of subject images, the parallax correction section corrects the magnitude of parallax for each of the subject images.

5. The image processor according to claim 4, further comprising a depth information obtaining section obtaining depth information based on the plurality of viewpoint images,
wherein the parallax correction section performs corrects the magnitude of parallax with use of the depth information.

6. The image processor according to claim 1, wherein
the parallax correction section corrects the magnitude of parallax to allow a stereoscopic image created from the plurality of viewpoint images to be shifted backward.

7. An image processing method comprising:
correcting magnitude of parallax, depending on position on an image plane, for each of a plurality of viewpoint images, the viewpoint images having been taken from respective viewpoints different from one another, and each having a nonuniform parallax distribution in the image plane.

8. An image pickup apparatus comprising:
an imaging lens;
a shutter allowed to switch between a transmission state and a shielding state of each of a plurality of optical paths;
an image pickup device detecting light rays which have passed through the respective optical paths, to output image pickup data each corresponding to a plurality of viewpoint images which are seen from respective viewpoints different from one another;
a control section controlling switching between the transmission state and the shielding state of the optical paths in the shutter; and
an image processing section performing image processing on the plurality of viewpoint images,
wherein the image processing section includes a parallax correction section correcting magnitude of parallax, depending on position on an image plane, for each of the plurality of viewpoint images.

9. The image pickup apparatus according to claim 8, wherein
the image pickup device is operated in a line sequential manner, and
the control section controls the shutter to switch between the transmission state and the shielding state of the optical paths at an operation timing of the image pickup device, the operation timing being delayed by a predetermined time length from a start timing of a first-line exposure in each image pickup frame.
